(19) United States
(12) Patent Application Publication
(10) Pub. No.: US 2026/0196240 A1
(43) Pub. Date: Jul. 9, 2026

(54) SOUND QUALITY EVALUATION METHOD AND SOUND QUALITY EVALUATION SYSTEM

(71) Applicant: ASUSTEK COMPUTER INC., TAIPEI (TW)

(72) Inventors: Yu-Chun CHIANG, TAIPEI (TW); Chang-Chih CHEN, TAIPEI (TW); Kuo-Yuan HUANG, TAIPEI (TW); Kun-Han TSAI, TAIPEI (TW); Tsung-Yen YU, TAIPEI (TW); Sheng-Yu HO, TAIPEI (TW); Wei-Chen KUAN, TAIPEI (TW)

(21) Appl. No.: 19/236,873

(22) Filed: Jun. 12, 2025

(30) Foreign Application Priority Data
Jan. 8, 2025 (TW) 114100775

(51) Int. Cl. G10L 25/60; G10L 25/18

(52) U.S. Cl. CPC G10L 25/60; G10L 25/18

(57) ABSTRACT

The disclosure provides a sound quality evaluation method, including: first, obtaining a plurality of pieces of training audio generated by a plurality of training apparatuses; subsequently, obtaining a plurality of training audio subjective evaluation scores corresponding to the plurality of pieces of training audio; next, segmenting each training audio into a plurality of frequency bands to generate a plurality of training audio frequency bands, and calculating energy of each training audio frequency band to generate a training audio objective evaluation score corresponding to the training audio; generating an evaluation adjustment function according to the plurality of training audio objective evaluation scores and the plurality of corresponding training audio subjective evaluation scores; obtaining a to-be-evaluated audio objective evaluation score of a to-be-evaluated apparatus; and generating a sound quality evaluation score according to the to-be-evaluated audio objective evaluation score and the evaluation adjustment function. The disclosure further provides a sound quality evaluation system.

### CROSS-REFERENCE TO RELATED APPLICATION

This application claims the priority benefit of Taiwan Application Serial No. 114100775, filed on Jan. 8, 2025. The entirety of the above-mentioned patent application is hereby incorporated by reference herein and made a part of specification.

### BACKGROUND OF THE INVENTION

### Field of the Invention

The disclosure relates to a sound quality evaluation method and a sound quality evaluation system.

### Description of the Related Art

When purchasing a playback apparatus, a consumer usually determines a preferred product by listening to an audio file played by the playback apparatus. Most product analyses of playback apparatuses on the network are evaluation from subjective feelings of experts. However, when all playback apparatuses on the market are to be evaluated by experts, in addition to consumed costs, a problem of inconsistent evaluation is prone to occur. In addition, although deviation from human subjective evaluation is avoided by objective evaluation obtained simply by using physical data, the preference of the consumer usually is not accurately reflected.

### BRIEF SUMMARY OF THE INVENTION

The disclosure provides a sound quality evaluation method, including the following steps: first, obtaining a plurality of pieces of training audio generated by a plurality of training apparatuses; subsequently, obtaining a plurality of training audio subjective evaluation scores corresponding to the plurality of pieces of training audio; next, segmenting each training audio into a plurality of frequency bands to generate a plurality of training audio frequency bands, and calculating energy of each training audio frequency band to generate a training audio objective evaluation score corresponding to the training audio; generating an evaluation adjustment function according to the plurality of training audio objective evaluation scores and the plurality of corresponding training audio subjective evaluation scores; obtaining a to-be-evaluated audio objective evaluation score of a to-be-evaluated apparatus; and generating a sound quality evaluation score according to the to-be-evaluated audio objective evaluation score and the evaluation adjustment function.

The disclosure further provides a sound quality evaluation system. The sound quality evaluation system includes a training module and an evaluation module. The training module includes an audio obtaining module, a subjective score obtaining module, a calculation module, and a processing module. The audio obtaining module is configured to obtain a plurality of pieces of training audio generated by a plurality of training apparatuses. The subjective score obtaining module is configured to obtain a plurality of training audio subjective evaluation scores corresponding to the plurality of pieces of training audio. The calculation module is configured to segment each training audio into a plurality of frequency bands to generate a plurality of training audio frequency bands, and calculate energy of each training audio frequency band to generate a training audio objective evaluation score corresponding to the training audio. The processing module is configured to generate an evaluation adjustment function according to the plurality of training audio objective evaluation score and the plurality of corresponding training audio subjective evaluation score. The evaluation module is configured to obtain a to-be-evaluated audio objective evaluation score generated by a to-be-evaluated apparatus, and generate a sound quality evaluation score according to the to-be-evaluated audio objective evaluation score and the evaluation adjustment function.

In the sound quality evaluation method and the sound quality evaluation system in the disclosure, an evaluation adjustment function is obtained by obtaining a subjective evaluation score and an objective evaluation score. With accumulation of training data, an evaluation score calculated by using a sound quality evaluation model in the disclosure effectively takes advantage of both subjective evaluation of a professional listener and objective evaluation of a physical quantity, thereby providing a more objective and consistent evaluation result. In addition, according to the sound quality evaluation method and the sound quality evaluation system provided in the disclosure, for a new to-be-evaluated apparatus, there is no need to search for the professional listener to provide subjective evaluation, and only an objective evaluation score needs to be obtained, so that a final sound quality evaluation score is calculated for sound quality evaluation. In this way, deviation from human subjective evaluation is avoided, and time and costs required for sound quality evaluation are also reduced.

### BRIEF DESCRIPTION OF THE DRAWINGS

FIG. 1 is a schematic diagram of an embodiment of a setting environment of a sound quality evaluation system according to the disclosure;

FIG. 2 is a schematic block diagram of a sound quality evaluation system according to an embodiment of the disclosure;

FIG. 3 is a curve diagram showing correlation between an objective evaluation score and a corresponding subjective evaluation score;

FIG. 4 is a flowchart of a sound quality evaluation method according to an embodiment of the disclosure; and

FIG. 5 shows an embodiment of step S460 in FIG. 4.

### DETAILED DESCRIPTION OF THE EMBODIMENTS

More detailed descriptions of specific embodiments of the disclosure are provided below with reference to the schematic diagrams. The advantages and features of the disclosure will be better understand according to the following description and appended claims. It needs to be noted that accompanying drawings are all in a simplified form and in an inaccurate scale. They are only used for assisting in describing the propose of the embodiments of the disclosure in a convenient and clear way.

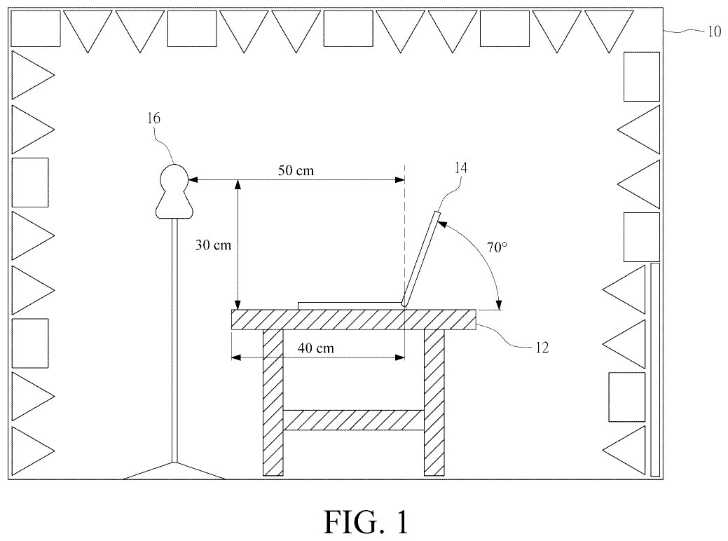

FIG. 1 is a schematic diagram of an embodiment of a setting environment of a sound quality evaluation system according to the disclosure.

As shown in the figure, the sound quality evaluation system in the disclosure is arranged in a listening room 10. The listening room 10 is a space that is suitable for appreciating an electro acoustic product or a speaker and that is set according to specifications of the European Telecommunications Standards Institute (ETSI) and the International Electronic Commission (ITC).

A standard testing table 12 is arranged in the listening room 10. The standard testing table 12 is a device configured to set up a tested apparatus 14 according to specifications of the International Organization for Standardization (ISO). The tested apparatus 14 is a notebook computer, an all-in-one computer, or another electronic apparatus having a sound generation function. A human-like dual-track microphone 16 is arranged in front of the tested apparatus 14, to obtain audio generated by the tested apparatus 14.

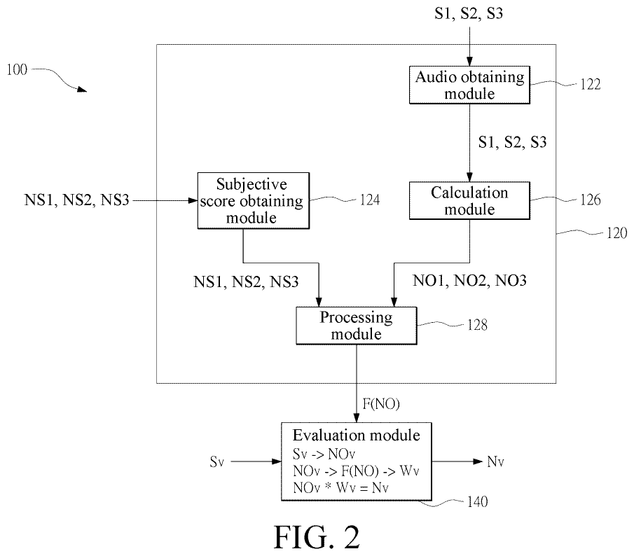

FIG. 2 is a schematic block diagram of a sound quality evaluation system 100 according to an embodiment of the disclosure. As shown in the figure, the sound quality evaluation system 100 includes a training module 120 and an evaluation module 140.

In the sound quality evaluation system 100 in the disclosure, training audio subjective evaluation scores NS1, NS2, and NS3 from a professional listener for training audio S1, S2, and S3 generated by training apparatuses and training audio objective evaluation scores NO1, NO2, and NO3 corresponding to energy of a plurality of frequency bands of the training audio S1, S2, and S3 are comprehensively considered to generate an evaluation adjustment function F(NO), and a to-be-evaluated audio objective evaluation score NOv of a to-be-evaluated apparatus is adjusted by using the evaluation adjustment function F(NO), to generate a sound quality evaluation score Nv.

As shown in the figure, the training module 120 includes an audio obtaining module 122, a subjective score obtaining module 124, a calculation module 126, and a processing module 128.

The audio obtaining module 122 is configured to obtain the plurality of pieces of training audio S1, S2, and S3 generated by the plurality of training apparatuses. In an embodiment, the audio obtaining module 122 includes a microphone. In an embodiment, the microphone is the human-like dual-track microphone 16 in FIG. 1. In an embodiment, a frequency range of each of the training audio S1, S2, and S3 obtained by the audio obtaining module 122 is 1 kHz to 20 kHz, that is, a frequency range corresponding to a human voice.

The subjective score obtaining module 124 is configured to obtain the plurality of training audio subjective evaluation scores NS1, NS2, and NS3 corresponding to the plurality of pieces of training audio S1, S2, and S3. In an embodiment, the training audio subjective evaluation scores NS1, NS2, and NS3 are scores provided by the professional listener for the training audio S1, S2, and S3. In another embodiment, the training audio subjective evaluation scores NS1, NS2, and NS3 are alternatively scores provided by a consumer, or are from market scoring data collected on the network.

The calculation module 126 is configured to segment each of the training audio S1, S2, and S3 into a plurality of frequency bands to generate a plurality of training audio frequency bands, and calculate energy of each training audio frequency band to generate the training audio objective evaluation scores NO1, NO2, and NO3 corresponding to the training audio S1, S2, and S3. In an embodiment, the calculation module 126 segments each of the training audio S1, S2, and S3 into 26 frequency bands.

In an embodiment, the calculation module 126 calculates energy of each training audio frequency band by using a machine learning algorithm and an objective evaluation function, to obtain the training audio objective evaluation scores NO1, NO2, and NO3. In an embodiment, the machine learning algorithm uses a gradient descent method, and a formula of the gradient descent method is: x^{t+1}=x^{t}−γ×Δƒ(x^{t}). f(x) is the objective evaluation function, x is the energy of each training audio frequency band, γ is a learning rate, Δf is a target score, and t is the number of update times. The machine learning algorithm optimizes the objective evaluation function by using the training audio S1, S2, and S3, for the evaluation module 140 to use. The processing module 128 is configured to generate the evaluation adjustment function F(NO) according to the plurality of training audio subjective evaluation scores NS1, NS2, and NS3 and the plurality of corresponding training audio objective evaluation scores NO1, NO2, and NO3.

In an embodiment, the processing module 128 obtains, by using an optimal gradient method, a subjective evaluation function corresponding to the plurality of training audio subjective evaluation scores NS1, NS2, and NS3, and generates, by using the subjective evaluation function and the foregoing objective evaluation function, the evaluation adjustment function F(NO) corresponding to a variation degree between the training audio subjective evaluation scores NS1, NS2, and NS3 and the training audio objective evaluation scores NO1, NO2, and NO3.

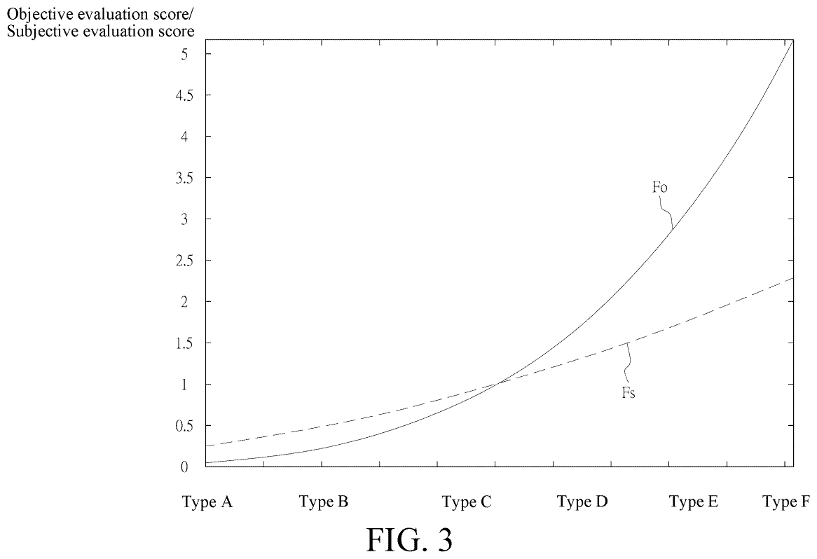

FIG. 3 is a curve diagram showing correlation between an objective evaluation score and a corresponding subjective evaluation score. A horizontal axis in the figure corresponds to different training apparatuses (that is, type A to type F in the figure), and a longitudinal axis represents the objective evaluation score and the subjective evaluation score. A solid line is an objective evaluation function Fo corresponding to the objective evaluation score, and a dashed line is a subjective evaluation function Fs corresponding to the subjective evaluation score.

The evaluation adjustment function F(NO) is described as follows. In the disclosure, a weight calculation method of the evaluation adjustment function F(NO) is mainly set according to a variation degree between the subjective evaluation score and the objective evaluation score. A larger difference between the subjective evaluation score and the objective evaluation score indicates a smaller weight output by the evaluation adjustment function F(NO). In an embodiment, the weight is set to a positive value less than or equal to 1. In addition, in a preferred embodiment, the weight is set to a positive value less than or equal to 1 and greater than or equal to 0.5. In an embodiment, when a difference between the subjective evaluation score and the objective evaluation score exceeds a first default value (in an embodiment, 2.5), the weight is set to 0.5. When the difference between the subjective evaluation score and the objective evaluation score is less than the first default value and exceeds a second default value (in an embodiment, 1), the weight is set to 0.75. When the difference between the subjective evaluation score and the objective evaluation score is less than the second default value, the weight is set to 1. In addition, in the foregoing embodiment, the difference between the subjective evaluation score and the objective evaluation score is compared. In another embodiment, a ratio of the subjective evaluation score to the objective evaluation score is alternatively compared.

It is known from FIG. 3 that, for a given objective evaluation score, a corresponding subjective evaluation score (or a difference between the subjective evaluation score and the objective evaluation score) is obtained, and then a weight corresponding to the objective evaluation score is determined. In this way, for the given objective evaluation score, a corresponding sound quality evaluation score Nv is obtained by multiplying the objective evaluation score by the corresponding weight.

Referring to FIG. 2 again, when sound quality of a new apparatus (to-be-evaluated apparatus) is evaluated, the evaluation module 140 first obtains to-be-evaluated audio data Sv generated by the to-be-evaluated apparatus, segments, according to a processing method the same as that of the calculation module 126, the to-be-evaluated audio data Sv into a plurality of frequency bands, and generates, according to energy of each frequency band, a to-be-evaluated audio objective evaluation score NOv corresponding to the to-be-evaluated audio data Sv.

Subsequently, the evaluation module 140 directly finds a corresponding to-be-evaluated audio weight Wv from the evaluation adjustment function F(NO) according to the to-be-evaluated audio objective evaluation score NOv, and then multiplies the to-be-evaluated audio objective evaluation score NOv by the to-be-evaluated audio weight Wv, to generate a sound quality evaluation score Nv.

In this way, according to the sound quality evaluation system 100 in the disclosure, for the new to-be-evaluated apparatus, there is no need to specifically search for a professional listener to provide a score, and the to-be-evaluated audio objective evaluation score NOv only needs to be directly multiplied by the to-be-evaluated audio weight Wv set by the evaluation adjustment function F(NO), to calculate the sound quality evaluation score Nv.

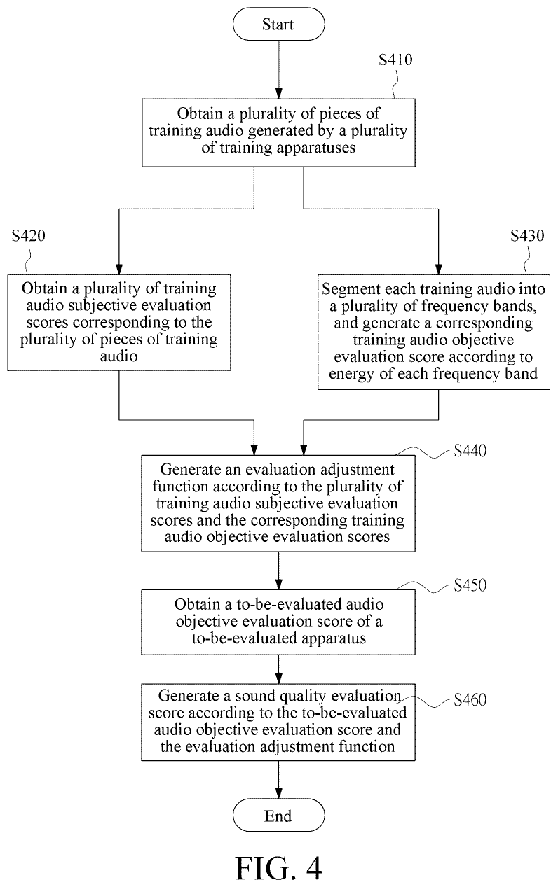

FIG. 4 is a flowchart of the sound quality evaluation method according to an embodiment of the invention. The sound quality evaluation method is suitable for the sound quality evaluation system 100 shown in FIG. 2. The sound quality evaluation method includes the following steps.

First, a training phase is entered. Step S410: Obtain a plurality of pieces of training audio S1, S2, and S3 generated by a plurality of training apparatuses. The step is performed by the audio obtaining module 120 in FIG. 2.
Step S420: Obtain a plurality of training audio subjective evaluation scores NS1, NS2, and NS3 corresponding to the plurality of pieces of training audio S1, S2, and S3. The step is performed by the subjective score obtaining module 140 in FIG. 2.
Step S430: Segment each of the training audio S1, S2, and S3 into a plurality of frequency bands to generate a plurality of training audio frequency bands, and calculate energy of each training audio frequency band to generate a plurality of training audio objective evaluation scores NO1, NO2, and NO3 corresponding to the plurality of pieces of training audio S1, S2, and S3. The step is performed by the calculation module 150 in the FIG. 2.
Step S440: Generate an evaluation adjustment function F(NO) according to the plurality of training audio objective evaluation scores NO1, NO2, and NO3 and the plurality of corresponding training audio subjective evaluation scores NS1, NS2, and NS3. The step is performed by the processing module 160 in FIG. 2.

Next, an evaluation phase is entered. Step S450: Obtain a to-be-evaluated audio objective evaluation score NOv of a to-be-evaluated apparatus. In an embodiment, in the step, to-be-evaluated audio data Sv generated by the to-be-evaluated apparatus is first obtained. Subsequently, a calculation method similar to that described in the foregoing step S430 is used to generate the to-be-evaluated audio objective evaluation score NOv according to the to-be-evaluated audio data Sv. The step is performed by the evaluation module 140 in FIG. 2 or performed by the audio obtaining module 120 and the calculation module 150 in FIG. 2.
Step S460: Generate a sound quality evaluation score Nv according to the to-be-evaluated audio objective evaluation score NOv and the evaluation adjustment function F(NO). The step is performed by the evaluation module 140 in FIG. 2.

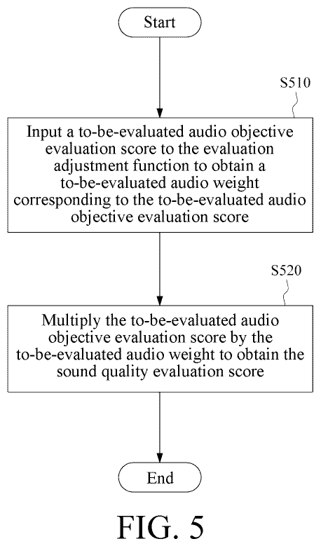

FIG. 5 shows an embodiment of step S460 in FIG. 4.
Step S510: Input the to-be-evaluated audio objective evaluation score Nov to the evaluation adjustment function F(NO) to obtain a to-be-evaluated audio weight Wv corresponding to the to-be-evaluated audio objective evaluation score.
Step S520: Multiply the to-be-evaluated audio objective evaluation score NOv by the to-be-evaluated audio weight Wv to obtain the sound quality evaluation score Nv.

Generally, scoring of a playback apparatus includes sound quality, sense of space, dynamics, sound volume, distortion, and the like. The sound quality evaluation method and the sound quality evaluation system 100 provided in FIG. 1 to FIG. 5 mainly provide scoring for the sound quality. However, the sound quality evaluation method and the sound quality evaluation system 100 provided in the disclosure are also applicable to scoring for features such as the sense of space, the dynamics, the sound volume, and the distortion. Subjective evaluation is considered in the objective evaluation score by using the weight obtained by the evaluation adjustment function. By using the sound volume as an example, subjective sound volume scores of a plurality of training apparatus are obtained. Training audio is used as an input, corresponding objective sound volume scores are calculated by using a sound volume evaluation algorithm, and then a corresponding evaluation adjustment function F(NO) is set according to a variation degree between the subjective sound volume scores and the objective sound volume scores. For a subsequent new to-be-evaluated apparatus, a score including both subjective evaluation and objective evaluation is generated by directly using an objective score and the evaluation adjustment function F(NO). Similarly, for features such as the sense of space, the dynamics, the sound volume, and the distortion, scores including both subjective evaluation and objective evaluation are obtained by using corresponding objective evaluation scores calculated by using algorithms and corresponding evaluation adjustment functions.

In conclusion, in the sound quality evaluation method and the sound quality evaluation system 100 in the disclosure, an evaluation adjustment function F(NO) is obtained by obtaining a subjective evaluation score and an objective evaluation score. With accumulation of training data, an evaluation score calculated by using a sound quality evaluation model in the disclosure effectively takes advantage of both subjective evaluation of a professional listener and objective evaluation of a physical quantity, thereby providing a more objective and consistent evaluation result. In addition, according to the sound quality evaluation method and the sound quality evaluation system 100 provided in the disclosure, for a new to-be-evaluated apparatus, there is no need to search for the professional listener to provide subjective evaluation, and only an objective evaluation score needs to be obtained, so that a final sound quality evaluation score Nv is calculated for sound quality evaluation. In this way, deviation from human subjective evaluation is avoided, and time and costs required for sound quality evaluation are also reduced.

The foregoing is merely exemplary embodiments of the disclosure, and does not constitute any limitation on the disclosure. Any form of equivalent replacements or modifications to the technical means and technical content disclosed in the disclosure made by a person skilled in the related art without departing from the scope of the technical means of the disclosure still fall within the content of the technical means of the disclosure and the protection scope of the disclosure.

What is claimed is:

1. A sound quality evaluation method, comprising:
obtaining a plurality of pieces of training audio generated by a plurality of training apparatuses;
obtaining a plurality of training audio subjective evaluation scores corresponding to the plurality of pieces of training audio;
segmenting each training audio into a plurality of frequency bands, and generating a corresponding training audio objective evaluation score according to energy of each of the plurality of frequency bands;
generating an evaluation adjustment function according to the plurality of training audio subjective evaluation scores and the corresponding training audio objective evaluation scores;
obtaining a to-be-evaluated audio objective evaluation score of a to-be-evaluated apparatus; and
generating a sound quality evaluation score according to the to-be-evaluated audio objective evaluation score and the evaluation adjustment function.

2. The sound quality evaluation method according to claim 1, wherein a frequency range of the training audio is 1 kHz to 20 kHz.

3. The sound quality evaluation method according to claim 1, wherein the training audio is segmented into 26 frequency bands.

4. The sound quality evaluation method according to claim 1, wherein an input of the evaluation adjustment function is an objective evaluation score, and an output of the evaluation adjustment function is a weight.

5. The sound quality evaluation method according to claim 4, wherein the weight is less than or equal to 1.

6. The sound quality evaluation method according to claim 4, wherein the output of the evaluation adjustment function corresponds to a variation degree between the training audio subjective evaluation scores and the corresponding training audio objective evaluation scores.

7. The sound quality evaluation method according to claim 4, wherein the step of generating a sound quality evaluation score according to the to-be-evaluated audio objective evaluation score and the evaluation adjustment function comprises:
inputting the to-be-evaluated audio objective evaluation score to the evaluation adjustment function to obtain a to-be-evaluated audio weight corresponding to the to-be-evaluated audio objective evaluation score; and
multiplying the to-be-evaluated audio objective evaluation score by the to-be-evaluated audio weight to obtain the sound quality evaluation score.

8. A sound quality evaluation system, comprising:
a training module, comprising:
an audio obtaining module, configured to obtain a plurality of pieces of training audio generated by a plurality of training apparatuses;
a subjective score obtaining module, configured to obtain a plurality of training audio subjective evaluation scores corresponding to the plurality of pieces of training audio;
a calculation module, configured to segment each training audio into a plurality of frequency bands to generate a plurality of training audio frequency bands, and calculate energy of each training audio frequency band to generate a plurality of training audio objective evaluation scores corresponding to the plurality of pieces of training audio; and
a processing module, configured to generate an evaluation adjustment function according to the plurality of training audio objective evaluation scores and the plurality of corresponding training audio subjective evaluation scores; and
an evaluation module, configured to obtain a to-be-evaluated audio objective evaluation score generated by a to-be-evaluated apparatus, and generate a sound quality evaluation score according to the to-be-evaluated audio objective evaluation score and the evaluation adjustment function.

9. The sound quality evaluation system according to claim 8, wherein an output of the evaluation adjustment function corresponds to a variation degree between the training audio subjective evaluation scores and the corresponding training audio objective evaluation scores.

10. The sound quality evaluation system according to claim 8, wherein an input of the evaluation adjustment function is an objective evaluation score, and an output of the evaluation adjustment function is a weight.

11. The sound quality evaluation system according to claim 10, wherein the weight is less than or equal to 1.

12. The sound quality evaluation system according to claim 8, wherein
the evaluation module is configured to:
input the to-be-evaluated audio objective evaluation score to the evaluation adjustment function to obtain a to-be-evaluated audio weight corresponding to the to-be-evaluated audio objective evaluation score; and
multiply the to-be-evaluated audio objective evaluation score by the to-be-evaluated audio weight to obtain the sound quality evaluation score.
